(19) United States
(12) Patent Application Publication
(10) Pub. No.: US 2026/0340069 A1
(43) Pub. Date: Oct. 29, 2026

(54) FIXED FORMULA BARYOGENESIS CALCULATOR DETERMINISTIC BARYON-TO- PHOTON RATIO AND BBN YIELD SERVICE USING RECOGNITION-PHYSICS DERIVED eta_B

(71) Applicant: Jonathan Washburn, Austin, TX (US)

(72) Inventor: Jonathan Washburn, Austin, TX (US)

(21) Appl. No.: 19/651,427

(22) Filed: Apr. 17, 2026

Related U.S. Application Data
(60) Provisional application No. 63/794,571, filed on Apr. 25, 2025.

(51) Int. Cl. G06F 17/11; G06F 9/50

(52) U.S. Cl. CPC G06F 17/11; G06F 9/5027

(57) ABSTRACT

A deterministic baryogenesis computation architecture receives a CP-violating phase input, delta_CP, and computes a baryon-to-photon ratio, eta_B, according to a fixed closed-form relation eta_B=A sin(delta_CP), where A is a fixed prefactor derived from stated Recognition-Physics conditions and delta_CP is treated as a measured input rather than a fitted cosmological parameter within the disclosed workflow. In some embodiments, the computed eta_B is output directly as the result of a formula-only kernel. In other embodiments, the computed eta_B is supplied to a nucleosynthesis engine to generate one or more primordial abundance outputs, including one or more of helium-4 abundance, deuterium abundance, lithium-7 abundance, and helium-3 abundance. In certain embodiments, the fixed prefactor is derived from X_opt=phi/pi and one or more additional fixed terms. The disclosed architecture may be implemented in software, hardware, local, hosted, batch, accelerated, or embedded environments.

### CROSS-REFERENCE TO RELATED APPLICATIONS

This application claims the benefit of U.S. Provisional Patent Application No. 63/794,571, filed Apr. 25, 2025. The subject matter disclosed in the present application is intended to be supported by, and to claim priority only to the extent supported by, U.S. Provisional Patent Application No. 63/794,571. To the extent any description herein is broader than or differently organized from the provisional disclosure, priority is claimed only for subject matter adequately supported in the provisional application. The disclosure of U.S. Provisional Patent Application No. 63/794,571 is incorporated herein by reference in its entirety.

### BACKGROUND OF THE INVENTION

The present disclosure pertains to early-universe physics computation, baryogenesis computation, and nucleosynthesis modeling, and more particularly to systems, methods, software, and computational architectures for determining a baryon-to-photon ratio from a CP-violating phase input and, in preferred embodiments, using that determined baryon-to-photon ratio in a Big-Bang Nucleosynthesis computation to generate one or more primordial abundance outputs.

The baryon-to-photon ratio, eta_B, is a significant cosmological quantity associated with matter-antimatter asymmetry and primordial element formation. Conventional nucleosynthesis workflows typically treat eta_B, or an equivalent baryon-density quantity, as an input parameter to a BBN code. In common practice, a user or analysis pipeline provides a candidate eta_B value, the BBN code evolves a nuclear reaction network, and resulting abundances are compared with observational constraints. Where parameter inference is desired, this process is often repeated across multiple eta_B values, including in scan-based, posterior-estimation, or MCMC-based workflows.

Accordingly, conventional workflows commonly treat eta_B as a free or fitted cosmological quantity within the computation pipeline. This creates a workflow in which multiple eta_B evaluations are used to explore or fit the baryon-density dimension, rather than deriving eta_B deterministically from an independently measured input quantity.

The present disclosure addresses this need by providing a deterministic baryogenesis computation architecture in which a CP-violating phase input, delta_CP, is used to compute eta_B by a fixed closed-form relation. In preferred embodiments, eta_B is computed according to eta_B=A sin(delta_CP), where A is a fixed prefactor derived from stated Recognition-Physics conditions rather than fitted within the disclosed workflow. In a primary applied embodiment, the computed eta_B is then supplied as the baryon input to a BBN computation to generate one or more primordial abundance outputs. Thus, the disclosed workflow replaces an internally fitted eta_B stage with a deterministic eta_B computation from delta_CP and, in some embodiments, collapses the eta_B scan dimension to a single computed value for subsequent nucleosynthesis evaluation.

The disclosed subject matter may be implemented in a variety of computing environments, including local software libraries, standalone executables, hosted services, batch-processing systems, accelerated CPU or GPU routines, and FPGA-based hardware embodiments. However, the inventive subject matter is not generic cloud deployment, generic scientific workflow orchestration, or generic use of a nucleosynthesis code. Rather, the inventive subject matter resides in the deterministic eta_B computation kernel itself, including the fixed-formula, fixed-prefactor, measured-not-fitted, and single-input character of that kernel, together with the closely related BBN-integrated embodiment in which the computed eta_B is used to generate primordial abundance outputs.

This disclosure therefore concerns a specific deterministic baryogenesis and nucleosynthesis-computation architecture, rather than a generic cosmology platform, generic cloud analytics system, or the entirety of any broader theoretical framework.

### SUMMARY OF THE INVENTION

The present disclosure provides a deterministic baryogenesis computation architecture in which a CP-violating phase input, delta_CP, is used to compute a baryon-to-photon ratio, eta_B, by a fixed closed-form relation: eta_B=A sin(delta_CP), where A is a fixed prefactor derived from stated Recognition-Physics conditions rather than fitted as a cosmological parameter within the disclosed workflow. In the disclosed architecture, delta_CP is measured, not fitted. Delta_CP is not a free parameter of the baryogenesis model. The core computation kernel requires only delta_CP as an external scientific input and deterministically computes eta_B from the fixed closed-form relation. In this manner, the disclosed computation kernel avoids fitting cosmological baryon-density parameters within the disclosed workflow and collapses the eta_B scan dimension of conventional scan-based or fit-based workflows to a single deterministic value derived from delta_CP.

In a primary applied embodiment, the computed eta_B is supplied as the baryon input to a Big-Bang Nucleosynthesis (BBN) computation. The BBN computation then generates one or more primordial abundance outputs, including, in representative embodiments, one or more of helium-4 abundance, deuterium abundance, lithium-7 abundance, and helium-3 abundance. Thus, in preferred embodiments, the disclosure provides an integrated computation pipeline that receives delta_CP, computes eta_B, injects the computed eta_B into a nucleosynthesis engine, and outputs one or more primordial abundance values.

In some embodiments, the invention is practiced as a formula-only kernel that receives delta_CP and outputs eta_B without executing a nucleosynthesis computation. In other embodiments, the invention is practiced as the integrated eta_B-plus-BBN pipeline described above. The formula-only kernel preserves the broadest statement of the inventive mechanism, while the BBN-integrated pipeline provides a primary applied embodiment with direct abundance-generation capability.

In preferred embodiments, the fixed prefactor A is derived from X_opt=phi/pi and from one or more additional fixed terms associated with the disclosed model architecture. In representative embodiments, A is expressed as: A=X_opt\hat{ }(21/2)×(m_p/T_EW)/(8pi\hat{ }2 g_star). and is therefore treated within the disclosed model architecture as fixed rather than as a user-selectable or cosmologically fitted parameter.

In certain embodiments, the disclosed architecture further includes one or more additional features, such as input validation, remapping of reported delta_CP values into a selected physical range, derivative computation, uncertainty propagation, batch evaluation across multiple delta_CP values, software library implementations, service interfaces, accelerated CPU or GPU execution, FPGA embodiments, machine-readable output packaging, benchmark comparison, and cross-platform verification. Such features may be advantageous in particular implementations. However, the core invention remains the deterministic eta_B computation kernel and the closely related BBN-integrated embodiment built around that kernel, rather than any particular interface, deployment environment, packaging choice, or validation presentation.

Accordingly, the disclosure provides a specific deterministic baryogenesis computation architecture and a closely related BBN-integrated embodiment, rather than a generic computing platform, generic cloud analytics system, or the entirety of any broader theoretical framework.

### BRIEF DESCRIPTION OF THE DRAWINGS

FIG. 1 depicts a top-level deterministic baryogenesis and BBN architecture in which a delta_CP input is optionally preprocessed and supplied to a fixed-formula engine that uses a fixed prefactor to compute eta_B, wherein the eta_B output is either returned directly or supplied to a BBN engine to generate one or more primordial abundance outputs, and wherein optional software/service and accelerator layers are shown as subordinate embodiments.

FIG. 2 depicts a core formula-computation workflow in which delta_CP is received, optionally validated and remapped, processed through a sine-evaluation stage and a prefactor stage, and used to compute eta_B, with optional derivative computation, uncertainty propagation, and eta_B output.

FIG. 3 depicts a fixed-prefactor architecture showing assembly of the prefactor A from X_opt and additional fixed terms, including an exponent term, an electroweak normalization term, a statistical dilution term, and a constant geometric factor, together with an indication of formal-verification support for the fixed-prefactor framing.

FIG. 4 depicts a BBN integration workflow in which computed eta_B is supplied through an adapter to a nucleosynthesis kernel, the kernel executes a reaction network, and one or more abundance outputs are generated and assembled into an output package.

FIG. 5 depicts software and service embodiments including, by way of example, a standalone library, a command-line or workstation embodiment, a REST interface, a batch or RPC interface, an eta-only mode, a full-BBN mode, an output formatter, and an optional logging, cache, or persistence block.

FIG. 6 depicts accelerated hardware embodiments including CPU, vectorized CPU, GPU, and FPGA implementations, together with optional fixed-point processing, sine-approximation logic, throughput or latency monitoring, and cross-platform verification.

FIG. 7 depicts validation and uncertainty handling, including an example delta_CP input, a computed eta_B value, one or more benchmark comparison blocks, abundance comparison logic, uncertainty propagation, and a comparison between conventional scan-based workflows and the disclosed deterministic workflow.

FIG. 8 depicts an embodiment taxonomy and claim-support map separating core subject matter from preferred, optional, alternative, prophetic, demonstrated, downstream, and continuation-target material.

### DETAILED DESCRIPTION OF THE INVENTION

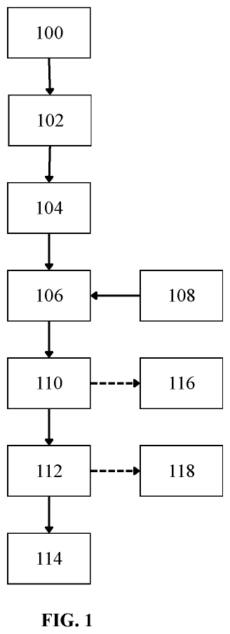

FIG. 1 depicts a top-level deterministic baryogenesis and BBN architecture 100 in which a CP-violating phase input 102, delta_CP, is optionally preprocessed by a preprocessing or range-mapping block 104 and supplied to a fixed-formula engine 106 that uses a fixed prefactor block 108 to compute a baryon-to-photon ratio eta_B 110. As further shown in FIG. 1, the computed eta_B 110 may be returned directly as an output or may be supplied to a BBN engine 112 to generate one or more abundance outputs 114. Optional software or service layer features 116 and optional accelerator-layer features 118 are also shown in FIG. 1 as subordinate embodiments. The present disclosure provides a deterministic baryogenesis computation architecture in which a CP-violating phase input, delta_CP, is used to compute a baryon-to-photon ratio, eta_B, by a fixed closed-form relation: eta_B=A sin(delta_CP) where A is a fixed prefactor derived from stated Recognition-Physics conditions rather than fitted as a cosmological parameter within the disclosed workflow.

In a primary applied embodiment, the computed eta_B is supplied as a baryon input to a Big-Bang Nucleosynthesis (BBN) computation to generate one or more primordial abundance outputs. In representative embodiments, the abundance outputs include one or more of helium-4 abundance, deuterium abundance, lithium-7 abundance, and helium-3 abundance. Accordingly, the disclosure includes both a formula-only computation kernel and a closely related BBN-integrated embodiment built around that kernel.

The formula-only kernel is itself a complete embodiment of the invention. In that embodiment, delta_CP is received, eta_B is deterministically computed from the fixed closed-form relation, and eta_B is output without requiring execution of a nucleosynthesis engine. This formula-only embodiment preserves the broadest statement of the inventive mechanism.

The BBN-integrated embodiment is a primary applied embodiment of the invention. In that embodiment, the computed eta_B is provided to a nucleosynthesis engine, which computes one or more primordial abundance outputs from the single computed eta_B value. This integrated embodiment preserves the practical and applied use of the disclosed deterministic eta_B computation while remaining centered on the same fixed-formula kernel.

In the disclosed architecture, delta_CP is measured, not fitted. Delta_CP is not a free parameter of the baryogenesis model. The core computation kernel requires only delta_CP as an external input and computes eta_B deterministically from the fixed closed-form relation. Accordingly, the disclosed workflow avoids fitting cosmological baryon-density parameters within the workflow itself and, in embodiments that replace scan-based workflows, collapses the eta_B scan dimension to a single deterministic value derived from delta_CP.

The invention is therefore not a generic cosmology platform, not a generic cloud analytics system, not merely a generic implementation of a nucleosynthesis code, and not the entirety of any broader Recognition Science or Recognition-Physics framework. Rather, the invention is the deterministic eta_B computation kernel and the closely related BBN-integrated embodiment built around that kernel, together with disclosed optional software, service, hardware, batch-processing, output-packaging, validation, and downstream-use embodiments.

Certain disclosed features are core to the inventive mechanism. These include the fixed closed-form relation, the fixed-prefactor structure, the measured-not-fitted role of delta_CP, the single-input character of the core kernel, and the resulting deterministic eta_B computation. Other disclosed features, while useful in practice, are optional or implementation-specific. Such optional features include, by way of example, input formatting, interface protocols, service layers, deployment environments, output schemas, accelerator hardware, batch orchestration, fixed-point implementations, validation dashboards, educational interfaces, and downstream scientific workflows.

The disclosed subject matter is also positioned, in certain embodiments, as a baryogenesis module within a broader Recognition-Physics or Recognition Science framework. In that context, the prefactor architecture and related formal support may rely on quantities and structures presented as Recognition-derived. However, engineering and deployment embodiments described herein, including software packaging, service interfaces, compute acceleration, and other implementation details, need not themselves be Recognition-derived in order to practice the invention. Such implementation embodiments may nevertheless be fully consistent with the disclosed deterministic eta_B computation kernel.

Accordingly, this detailed description is structured to preserve a clear hierarchy of disclosure: first, the core formula-only kernel; second, the primary BBN-integrated embodiment; third, preferred and optional implementation embodiments; fourth, demonstrated validation material; and fifth, prophetic, downstream, and continuation-oriented material. This structure is intended to preserve clarity of the invention, support broad and fallback claim positions, and avoid conflating core mechanism with optional implementation or future application layers.

This organizational hierarchy is intended as a drafting and explanatory structure only. Subject matter described in broader, alternative, downstream, prophetic, or future-facing terms should be understood as supporting the present disclosure only to the extent adequately described and enabled, and priority to any earlier-filed provisional application is claimed only to the extent such subject matter is supported therein.

As used in the present disclosure, the following terms have the meanings set forth below unless the context clearly indicates otherwise.

The term “baryon-to-photon ratio” or “eta_B” refers to a ratio representing baryon number relative to photon number and is used herein as the baryogenesis output quantity computed by the disclosed deterministic computation kernel.

For document-formatting clarity, and without changing meaning, the following ASCII-safe equivalents may be used interchangeably throughout this disclosure: eta_B for η_B, delta_CP for δ_CP, delta_bar_CP for δ⁻_M CP, phi for φ, pi for π, and g_star for g_star. The term “CP-violating phase” or “delta_CP” refers to a phase input associated with charge-parity violation and used by the disclosed computation kernel as the external input from which eta_B is computed. In preferred embodiments, delta_CP corresponds to a neutrino-sector CP-violating phase, such as a PMNS Dirac CP phase, although the disclosure is not limited to any particular experimental source unless expressly stated in a given embodiment.

The term “delta_bar_CP” refers to an optionally remapped form of delta_CP used in embodiments in which an input value reported in one range is converted into another selected physical or computational range prior to evaluating the fixed closed-form relation.

The term “fixed closed-form relation” refers to a predetermined mathematical expression used to compute eta_B from delta_CP without fitting eta_B as a cosmological parameter within the disclosed workflow. In preferred embodiments, the fixed closed-form relation is eta_B=A sin(delta_CP), although equivalent notation, remapped input forms, or mathematically equivalent implementations may be used in particular embodiments.

The term “fixed prefactor” or “A” refers to the multiplicative factor in the disclosed closed-form relation for eta_B. Within the disclosed model architecture, A is treated as fixed rather than as a user-selectable, scan-varied, or cosmologically fitted parameter.

The term “X_opt” refers to a Recognition-derived quantity that, in preferred embodiments, is defined as X_opt=phi/pi and is used in the derivation or assembly of the disclosed fixed prefactor A. As used herein, the phrase “derived from stated Recognition-Physics conditions” means that A is treated within the disclosed model architecture as a predetermined value or a deterministically computed value based on stated fixed terms (for example, based on X_opt and one or more additional fixed factors) and is not iteratively fitted, optimized, scanned, or sampled as a cosmological parameter within the disclosed workflow.

The term “deterministic computation” refers to a computation in which the disclosed workflow computes eta_B from the provided delta_CP input by the fixed closed-form relation, rather than deriving eta_B through a scan, posterior search, MCMC chain, or other iterative fitting procedure over candidate eta_B values.

The term “measured parameter” refers to a quantity that is obtained from an external measurement source, experimental report, stored dataset, or externally provided value, rather than being internally varied or fitted within the disclosed workflow.

The term “fitted parameter” refers to a quantity that is estimated, optimized, scanned, sampled, or otherwise varied within a computational workflow to obtain a desired match to observational, theoretical, or benchmark criteria.

The term “nucleosynthesis engine,” “BBN engine,” or “nucleosynthesis computation” refers to a computational component configured to receive a baryon-to-photon ratio and compute one or more primordial abundance outputs. In preferred embodiments, the nucleosynthesis engine comprises or interfaces with a Big-Bang Nucleosynthesis code, such as AlterBBN, although other suitable nucleosynthesis solvers may be used in other embodiments.

The term “eta-only mode” refers to an embodiment in which the disclosed system or method receives delta_CP, computes eta_B, and outputs eta_B without executing a nucleosynthesis computation.

The term “BBN-integrated embodiment” refers to an embodiment in which the disclosed system or method computes eta_B from delta_CP and supplies the computed eta_B to a nucleosynthesis engine to generate one or more primordial abundance outputs.

The term “abundance output” refers to any computed output characterizing one or more primordial element abundances or related nucleosynthesis quantities. In representative embodiments, abundance outputs include one or more of helium-4 abundance, deuterium abundance, lithium-7 abundance, and helium-3 abundance, whether expressed as mass fractions, ratios, normalized quantities, or other suitable output forms.

The term “batch mode” refers to an embodiment in which the disclosed system processes multiple delta_CP values, multiple eta_B computations, multiple BBN computations, or combinations thereof in a single scheduled, grouped, or orchestrated execution.

The term “validation mode” refers to an embodiment or operational mode in which one or more internal checks, benchmark comparisons, uncertainty calculations, cross-platform comparisons, or acceptance criteria are applied to confirm or characterize operation of the disclosed computation kernel or the BBN-integrated embodiment.

The term “output package” refers to a machine-readable, human-readable, or mixed-format output containing one or more of delta_CP, delta_bar_CP, eta_B, abundance outputs, derivative values, uncertainty values, timing information, provenance information, validation data, or related metadata.

The term “single input” means that only delta_CP is required as an external scientific input to the core deterministic eta_B computation kernel. Optional metadata, formatting information, interface instructions, software-call parameters, deployment settings, or validation options do not alter the single-input character of the core kernel.

The term “zero fitted cosmological parameters within the disclosed workflow” means that, within the disclosed eta_B computation kernel and the closely related BBN-integrated embodiment, the baryon-to-photon ratio is computed from delta_CP by the fixed closed-form relation rather than being internally fitted, scanned, sampled, or optimized as a cosmological parameter.

Unless expressly stated otherwise, terms such as “preferred,” “optional,” “alternative,” “prophetic,” “downstream,” and “continuation-oriented” are used in this disclosure to distinguish levels of support, implementation priority, or strategic categorization, and are not intended to limit claim scope except where specifically recited in a claim.

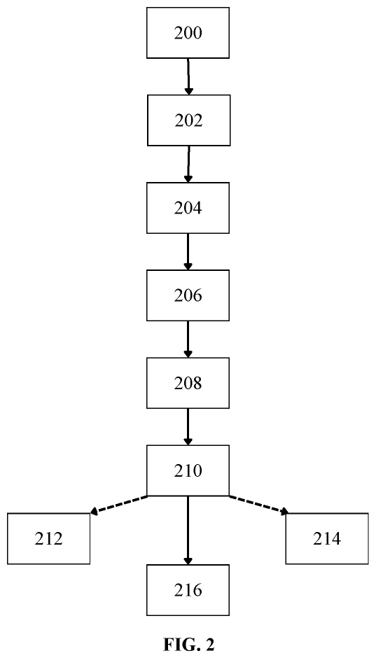

As shown in FIG. 2, a core formula-computation workflow 200 may include receiving delta_CP at step 200, optionally validating the input at step 202, optionally remapping the input to delta_bar_CP at step 204, evaluating a sine term at step 206, retrieving or assembling the prefactor A at step 208, computing eta_B at step 210, optionally computing a derivative at step 212, optionally performing uncertainty propagation at step 214, and outputting eta_B at step 216.

In the disclosed architecture, the core baryogenesis computation kernel computes a baryon-to-photon ratio, eta_B, from a CP-violating phase input, delta_CP, according to a fixed closed-form relation. In preferred embodiments, the relation is: eta_B=A sin(delta_CP) where A is a fixed prefactor within the disclosed model architecture.

The core kernel is deterministic. Upon receipt of delta_CP, the kernel evaluates the closed-form relation and produces eta_B without internally fitting eta_B, without scanning over candidate eta_B values, and without requiring a posterior-estimation or MCMC procedure to determine eta_B within the disclosed workflow.

The core kernel requires only delta_CP as an external scientific input. In this sense, delta_CP is the single external input required by the core formula kernel. Optional metadata, interface instructions, configuration parameters, formatting selections, batch-control parameters, logging options, or deployment settings do not change the single-input character of the scientific computation itself.

Within the disclosed workflow, delta_CP is measured, not fitted. Delta_CP is not treated as a free baryogenesis parameter to be optimized within the workflow. Rather, delta_CP is supplied from an external source, such as a user input, a stored value, an experimental dataset, a reporting pipeline, or another computation, and the disclosed kernel uses that supplied value to compute eta_B deterministically.

The fixed-prefactor structure is also part of the core kernel. In preferred embodiments, A is not a user-selectable tuning knob, not a scan variable, and not a fitted cosmological parameter. Instead, A is fixed within the disclosed model architecture and is used as a determinate multiplicative factor in the closed-form relation for eta_B.

Accordingly, the disclosed core formula kernel eliminates the need to fit eta_B inside the computation workflow. In embodiments that replace scan-based or fit-based cosmological workflows, the disclosed kernel collapses the eta_B scan dimension to a single deterministic value derived from delta_CP.

The core formula kernel may be practiced as a complete standalone embodiment. In such embodiments, the kernel receives delta_CP, optionally performs input checking or range normalization, evaluates the fixed closed-form relation, and outputs eta_B. No nucleosynthesis engine is required in order to practice the formula-only embodiment.

In other embodiments, the same core kernel serves as the front-end stage of a larger integrated pipeline. In those embodiments, the eta_B value computed by the core kernel is supplied to a downstream nucleosynthesis computation. Even in such integrated embodiments, however, the identity of the inventive kernel remains the deterministic fixed-formula computation of eta_B from delta_CP.

In certain preferred embodiments, the core formula kernel also computes one or more related quantities derived directly from the same fixed relation, including, by way of example, a derivative with respect to delta_CP, an uncertainty propagation quantity, a boundedness check, a positivity check, or an order-of-magnitude check. Such quantities may be used for validation, reporting, sensitivity analysis, or downstream processing, but do not alter the fixed closed-form and single-input nature of the core kernel.

In some embodiments, the disclosed fixed closed-form relation is evaluated using delta_CP directly. In other embodiments, the relation is evaluated using an optionally remapped value, such as delta_bar_CP, where the remapping places the input into a selected physical or computational range before the sine term is evaluated. Whether delta_CP is used directly or through an expressly disclosed remapped form, the core formula kernel remains a deterministic computation of eta_B from the CP-phase input by a fixed closed-form rule.

Thus, the core formula kernel is characterized by at least the following features: a fixed closed-form eta_B relation, a fixed prefactor, a measured-not-fitted delta_CP input, a single-input scientific computation structure, deterministic eta_B output generation, and avoidance of internal eta_B fitting within the disclosed workflow.

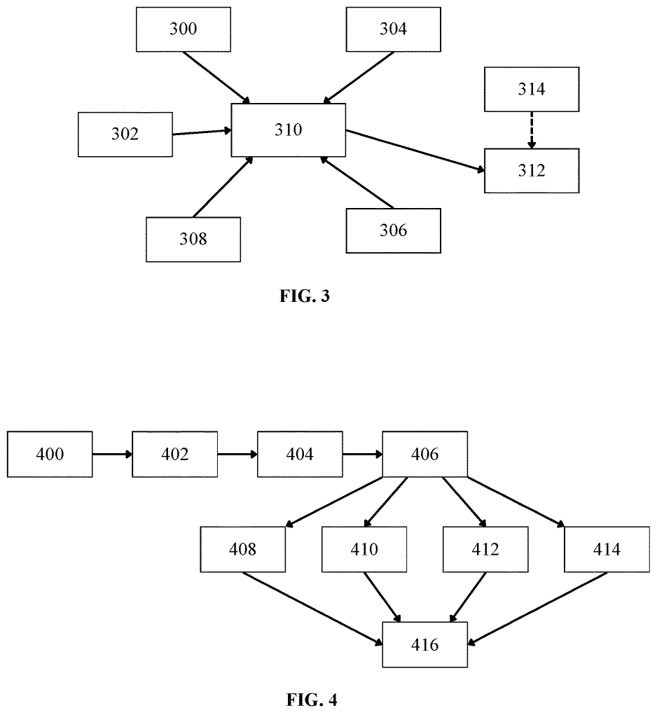

As shown in FIG. 3, a fixed-prefactor architecture 300 may include an X_opt input 300, an exponent term 302 corresponding to X_opt\hat{ }(21/2), an electroweak normalization term 304, a statistical dilution term 306, and a constant geometric factor 308. These terms may be combined in a prefactor assembly block 310 to yield a fixed prefactor A 312. FIG. 3 also shows a formal-verification support indicator 314 denoting that one or more mathematical properties of the fixed-prefactor framing may be supported by machine-checked formalization.

In preferred embodiments, the prefactor A used in the closed-form baryogenesis relation is fixed within the disclosed model architecture and is not treated as a user-selectable parameter, a scan variable, or a cosmologically fitted quantity.

In a preferred formulation, the disclosed relation is: eta_B=A sin(delta_CP) with A derived from a Recognition-Physics structure that includes X_opt=phi/pi and one or more additional fixed terms. In representative embodiments, A is expressed as: A =X_opt\hat{ }(21/2)×(m_p/T_EW)/(8pi\hat{ }2 g_star) where X_opt is defined as phi/pi, m_p/T_EW is an electroweak normalization term, 1/(8 pi\hat{ }2) is a constant geometric factor, and 1/g_star is a statistical dilution term.

Within the disclosed model architecture, these constituent terms are treated as fixed terms used to assemble the prefactor A. Accordingly, A is presented in the disclosure as a determined prefactor of the baryogenesis relation rather than a free cosmological fitting knob.

In preferred embodiments, X_opt provides the Recognition-derived structural input to the prefactor. The exponent term X_opt\hat{ }(21/2) supplies a disclosed baryogenesis-scaling component. The factor m_p/T_EW supplies a disclosed normalization component associated with proton and electroweak scales. The factor 1/(8 pi\hat{ }2) supplies a constant geometric contribution. The factor 1/g_star supplies a disclosed dilution or degrees-of-freedom contribution. These terms are combined multiplicatively to yield the fixed prefactor A used in the eta_B computation.

The significance of the fixed-prefactor structure is that the disclosed workflow does not determine eta_B by fitting A to observational data within the computation itself. Rather, the disclosed workflow receives delta_CP, applies the fixed relation using the fixed prefactor A, and computes eta_B directly.

In some embodiments, A is stored as a predetermined constant value, such as an implementation constant corresponding to the disclosed fixed architecture. In other embodiments, A is assembled or regenerated from the constituent fixed terms at runtime, initialization time, compile time, or configuration time. In either case, the role of A remains the same: A is fixed within the disclosed model architecture and is not varied as part of an internal cosmological fitting procedure.

In certain preferred embodiments, the disclosed fixed-prefactor framing is supported by formal verification or machine-checked mathematical formalization of one or more related properties. In representative embodiments, such formal support includes machine-checked results corresponding to positivity of the prefactor, derivation of the prefactor from X_opt, positivity of eta_B over a selected phase range, boundedness of eta_B relative to the prefactor, the single-input character of the kernel, order-of-magnitude characterization, and parameter-free treatment of the prefactor within the disclosed model structure. In this manner, formal support serves not merely as an optional presentation feature, but as a credibility anchor for the fixed-prefactor and fixed-formula framing of the disclosed deterministic baryogenesis kernel.

Accordingly, this section should be understood as distinguishing two different kinds of choices. The first kind consists of structural terms that are fixed within the disclosed model architecture and used to determine A. The second kind consists of implementation choices, such as how A is stored, how constituent terms are represented numerically, or how the computation is deployed in software or hardware. The latter may vary by embodiment, but they do not change the fixed-prefactor character of the disclosed baryogenesis kernel.

As shown in FIG. 2, the disclosed workflow may include receipt of delta_CP, optional validation and remapping, and subsequent formula evaluation.

In the disclosed architecture, the core computation kernel receives a CP-violating phase input, delta_CP, from any suitable source and prepares that input for deterministic evaluation by the fixed closed-form baryogenesis relation.

In some embodiments, delta_CP is received as a direct user input. In other embodiments, delta_CP is received from a stored file, a software call, an experimental data product, a remote service, a reporting pipeline, a database record, or another machine-readable source. The manner in which delta_CP is supplied may vary by embodiment and does not alter the underlying deterministic character of the core formula kernel.

In preferred embodiments, the disclosed workflow includes an input-acquisition stage in which a value corresponding to delta_CP is received and associated with one or more optional metadata items. Such metadata may include, by way of example, a source identifier, an experimental provenance tag, a timestamp, an uncertainty estimate, a reporting convention, a units or formatting flag, or a batch identifier. Such metadata may be useful for traceability, validation, or downstream processing, but is not required for the core scientific computation once delta_CP itself is available.

In some embodiments, the received delta_CP value is subjected to one or more preliminary validation checks before formula evaluation. Such checks may include determining whether the value is present, whether the value is numeric, whether the value falls within an expected reporting range, whether the value is associated with a recognized source or record type, or whether required supporting metadata is available. These checks may be used to improve robustness of a particular implementation, but need not be required in every embodiment.

In certain embodiments, the workflow includes a preprocessing step in which a reported delta_CP value is remapped into a selected physical or computational range before evaluating the fixed closed-form relation. In a representative embodiment, the preprocessing logic may be expressed as follows: if delta_CP<0 then delta_bar_CP=delta_CP+pi else delta_bar_CP=delta_CP.

In such embodiments, delta_bar_CP may be used as the phase value supplied to the sine term of the closed-form relation. In other embodiments, delta_CP is used directly without remapping. Whether remapping is applied may depend on the reporting convention associated with the source value, the desired physical interpretation, or the implementation policy of a particular system.

In some embodiments, both the originally received delta_CP value and the remapped delta_bar_CP value are retained. This may be advantageous for auditability, reproducibility, downstream comparison, or user reporting. For example, an output package may include the raw reported value, the processed value used in the computation, and one or more indicators specifying whether remapping occurred.

In embodiments in which multiple candidate delta_CP values are available, the disclosed architecture may optionally apply a source-selection or value-selection policy. For example, a system may select a user-specified value, a value from a preferred source, a most recent value, a combined-fit value, a median or representative value from a candidate set, or another selected input value according to an implementation policy. Such source-selection logic is optional and does not alter the single-input character of the core computation once a particular delta_CP value has been selected for use.

In batch embodiments, the input-acquisition stage may receive multiple delta_CP values in a single request, file, stream, or scheduled job. Each value may then be processed independently through the same validation, optional remapping, and formula-evaluation pipeline. In such embodiments, the system may preserve one-to-one associations among each received delta_CP value, any remapped value, the corresponding computed eta_B value, and any downstream abundance outputs.

In certain implementations, the preprocessing stage may also assign or generate one or more internal control values used only for computation management. Such values may include array indices, job identifiers, cache keys, validation flags, or execution-order markers. These implementation details may support efficient processing but do not constitute additional scientific inputs to the core kernel.

Accordingly, the input-acquisition and preprocessing stage may include one or more of receipt, parsing, validation, optional remapping, optional source selection, optional metadata association, and optional batching. However, the disclosed scientific computation remains centered on the deterministic evaluation of eta_B from a selected delta_CP value by the fixed closed-form relation. Optional preprocessing steps may improve robustness, traceability, and interoperability, but do not change the underlying inventive mechanism.

As further shown in FIG. 2, the selected phase input may be processed through sine evaluation, prefactor handling, eta_B computation, and optional derivative or uncertainty operations.

Following acquisition of a selected delta_CP value, and following any optional validation or preprocessing steps, the disclosed computation kernel evaluates the fixed closed-form baryogenesis relation to determine the baryon-to-photon ratio eta_B.

In preferred embodiments, the evaluation stage computes eta_B according to: eta_B=A sin(delta_CP) or, in embodiments employing a remapped phase value, according to: eta_B=A sin(delta_bar_CP) where A is the fixed prefactor described above and delta_bar_CP, when used, is derived from delta_CP by a disclosed preprocessing rule.

In some embodiments, the evaluation stage includes retrieving a stored value of A from memory or another accessible storage location. In other embodiments, the evaluation stage includes assembling or regenerating A from constituent fixed terms, such as X_opt, an exponent term, an electroweak normalization term, a statistical dilution term, and a constant geometric factor. Whether A is retrieved or assembled may vary by implementation, but in either case the evaluation stage applies a fixed prefactor within the disclosed model architecture.

The sine term may be evaluated using any suitable computational approach. In some embodiments, the sine term is computed using a standard floating-point trigonometric routine. In other embodiments, the sine term is computed using a lookup table, polynomial approximation, fixed-point logic, vectorized routine, hardware block, accelerator-specific function, or another numerical implementation. Such numerical implementation choices may affect speed, power consumption, or precision characteristics of a given embodiment, but do not change the fixed closed-form nature of the disclosed relation.

In the simplest formula-only embodiment, the evaluation stage performs the following sequence:
(a) receive a selected phase value;
(b) identify the phase value to be used in the sine term, whether delta_CP or delta_bar_CP;
(c) retrieve or assemble the fixed prefactor A;
(d) evaluate the sine term;
(e) multiply the sine term by A; and
(f) output eta_B.

In certain embodiments, the evaluation stage further computes one or more related quantities derived directly from the same closed-form relation. For example, the system may compute a derivative with respect to delta_CP according to: d eta_B/d delta_CP=A cos(delta_CP) or, where a remapped phase value is used, an analogous derivative expression based on the selected evaluation variable. Such derivative quantities may be used for sensitivity analysis, uncertainty propagation, reporting, validation, or downstream calculations.

In some embodiments, the disclosed workflow further propagates uncertainty associated with delta_CP into an uncertainty estimate for eta_B. For example, a first-order uncertainty estimate may be determined using the derivative expression above together with an uncertainty interval or error value associated with delta_CP. Such uncertainty propagation may be used to characterize confidence intervals, expected variation, forecast sensitivity, or experimental dependency, but need not be required in every embodiment.

In certain embodiments, the evaluation stage includes one or more internal consistency checks or validation checks. By way of example, the system may check whether eta_B is positive in an expected physical range, whether the absolute value of eta_B is bounded by A, whether eta_B lies within an expected order of magnitude, whether the output is numerically finite, or whether independently implemented execution paths yield the same or sufficiently similar result. Such checks may support quality assurance, debugging, certification, or validation modes, but are not necessarily required limitations of the core formula evaluation itself.

In preferred embodiments, the disclosed formula-evaluation stage is consistent with machine-checked formal support for one or more mathematical properties of the closed-form relation. Such properties may include positivity over a selected phase range, boundedness relative to the prefactor, and the single-input character of the kernel. The formal support may be described elsewhere in the specification as a credibility anchor for the disclosed fixed-formula architecture, but the practical make-and-use disclosure remains grounded in the operational evaluation steps described herein.

The formula-evaluation stage may be executed in scalar form, batch form, pipeline form, vectorized form, or hardware-accelerated form. In batch embodiments, multiple selected phase values may be processed independently through the same evaluation logic, with each input producing a corresponding eta_B output. In pipeline embodiments, the evaluation stage may be coupled directly to a downstream BBN computation stage, while in formula-only embodiments the evaluation stage may terminate with eta_B output generation.

Accordingly, the formula-evaluation stage provides a concrete operational implementation of the core inventive mechanism: a deterministic computation of eta_B from a selected CP-phase input by a fixed closed-form relation using a fixed prefactor, with optional derivative, uncertainty, validation, batching, and implementation-specific numerical features layered around that core calculation.

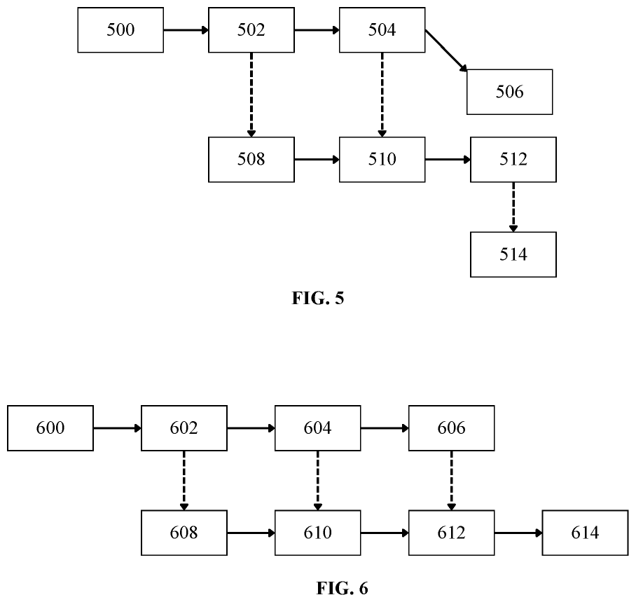

As shown in FIG. 5, certain software and service embodiments may include an eta-only mode 508 in which the disclosed deterministic baryogenesis kernel computes and returns eta_B without invoking a nucleosynthesis engine. FIG. 2 likewise illustrates that the core formula-computation workflow may terminate at eta_B output step 216 as a complete formula-only embodiment.

In certain embodiments, the disclosed invention is practiced as an eta-only computation mode in which the deterministic baryogenesis kernel receives a selected CP-phase input, evaluates the fixed closed-form relation, and outputs eta_B without executing a nucleosynthesis computation. This eta-only mode is itself a complete embodiment of the invention and preserves the broadest practical expression of the disclosed formula kernel.

In the simplest eta-only embodiment, the system receives delta_CP, optionally performs validation or preprocessing, computes eta_B according to the fixed closed-form relation, and returns eta_B as the primary output. In such embodiments, the output may be provided immediately after formula evaluation, without invoking a BBN engine, reaction-network solver, or abundance-generation stage.

The eta-only output may take any suitable form. In some embodiments, eta_B is returned as a scalar numeric value. In other embodiments, eta_B is returned in a structured output package that further includes one or more related fields, such as the input delta_CP value, an optionally remapped delta_bar_CP value, a prefactor identifier or prefactor value, an uncertainty estimate, a derivative value, a validation flag, a timestamp, a source identifier, or execution timing information.

In some embodiments, the eta-only output is packaged in a machine-readable format suitable for use by another software component. For example, eta_B may be returned as a record, object, array element, structured message, file entry, table row, or serialized output suitable for downstream computational use. In other embodiments, eta_B may be rendered in a human-readable form, such as a console output, report line, display field, dashboard element, or printed value.

In batch embodiments, the eta-only mode may receive multiple phase inputs and may output a corresponding set of eta_B values. Each output may preserve association with the corresponding input value and, where applicable, with any associated metadata or validation information. Thus, the eta-only mode may produce a vector, table, file, stream, or other multi-entry output structure containing multiple delta_CP-to-eta_B associations.

In some embodiments, the eta-only mode further includes optional sensitivity information. For example, the output may include d eta_B/d delta_CP, an uncertainty interval, an upper or lower bound, or a status indicator reflecting whether one or more validation conditions were satisfied. Such additional information may be useful for scientific interpretation, auditability, or downstream processing, but need not be required in every embodiment.

In certain embodiments, the eta-only mode is especially advantageous where the user or downstream system requires a deterministic baryogenesis output without requiring full nucleosynthesis yields. By way of example, the eta-only mode may be used in scientific comparison workflows, validation workflows, lookup-table generation workflows, precomputation workflows, sensitivity studies, screening tasks, or systems in which a downstream component consumes eta_B independently of any immediately coupled BBN engine.

In some implementations, the eta-only mode may be exposed as a distinct operational path or endpoint separate from a BBN-integrated mode. In other implementations, the eta-only mode may be invoked by configuration, by user selection, by command argument, by software call, or automatically when abundance outputs are not requested. The mechanism by which eta-only mode is selected may vary by embodiment and does not alter the identity of the eta-only embodiment as a complete practice of the formula kernel.

In some embodiments, the eta-only mode is used to generate scalar outputs, machine-readable output objects, batch output records, or precomputed lookup products based on one or more delta_CP inputs.

Accordingly, the eta-only output embodiments provide a direct and complete implementation of the disclosed deterministic baryogenesis computation kernel, in which eta_B is computed from delta_CP by the fixed closed-form relation and returned as an output product independent of any nucleosynthesis stage.

As shown in FIG. 4, a BBN integration workflow 400 may include supplying the computed eta_B 400 through a BBN adapter 402 to a nucleosynthesis kernel 404, executing a reaction-network stage 406, and generating one or more abundance outputs, such as helium-4 output 408, deuterium output 410, lithium-7 output 412, and helium-3 output 414, which may be assembled into a formatted abundance package 416.

In a primary applied embodiment, the disclosed deterministic baryogenesis computation kernel is integrated with a nucleosynthesis computation so that the baryon-to-photon ratio eta_B computed from delta_CP is used as the baryon input to a Big-Bang Nucleosynthesis engine. In this embodiment, the disclosed system not only computes eta_B deterministically from the fixed closed-form relation, but also generates one or more primordial abundance outputs from that computed eta_B value.

In preferred embodiments, the BBN-integrated workflow includes the following sequence:
(a) receive delta_CP;
(b) optionally validate or preprocess delta_CP;
(c) compute eta_B by the fixed closed-form relation;
(d) provide the computed eta_B to a nucleosynthesis engine;
(e) execute a nucleosynthesis computation using the provided eta_B; and
(f) output one or more resulting primordial abundance values, optionally together with eta_B and related metadata.

The nucleosynthesis engine may take any suitable form capable of receiving a baryon-to-photon ratio and generating one or more primordial abundance outputs. In preferred embodiments, the nucleosynthesis engine comprises or interfaces with a Big-Bang Nucleosynthesis code. In a particularly preferred embodiment, the nucleosynthesis engine comprises AlterBBN or an AlterBBN-based computation path. However, the broader BBN-integrated embodiment is not limited to any particular codebase unless expressly recited in a claim.

In some embodiments, integration between the deterministic eta_B kernel and the nucleosynthesis engine is implemented through an adapter or interface layer. The adapter may accept the computed eta_B value, transform it into a form expected by the selected BBN engine, load it into memory or configuration structures used by that engine, invoke the reaction-network calculation, and collect one or more resulting outputs. Such an adapter may also manage unit conventions, parameter passing, version compatibility, error handling, logging, or execution orchestration.

In preferred embodiments, the nucleosynthesis computation generates one or more abundance outputs selected from helium-4 abundance, deuterium abundance, lithium-7 abundance, and helium-3 abundance. These outputs may be represented as mass fractions, abundance ratios, normalized yields, or other suitable output forms depending on the selected BBN engine and the reporting mode of the implementation.

In some embodiments, the BBN-integrated workflow returns the full set of available abundance outputs generated by the nucleosynthesis engine. In other embodiments, the workflow returns only a selected subset of outputs. For example, a user or downstream process may request only helium-4 abundance, only deuterium abundance, only lithium-7 abundance, or any selected combination of available outputs. The selection policy may be specified by configuration, function call, interface parameter, preset mode, or another implementation mechanism.

In one representative embodiment, the BBN-integrated workflow may be described as follows. A selected delta_CP value is received. The system computes eta_B by evaluating eta_B=A sin(delta_CP), or an equivalent disclosed remapped-input formulation. The computed eta_B is then supplied to the BBN engine as the baryon input. The BBN engine executes its reaction-network computation over the relevant time or state-evolution interval. One or more primordial abundance outputs are then extracted and returned, optionally together with eta_B, uncertainty information, derivative information, execution timing information, validation information, and provenance metadata.

In certain implementations, the BBN-integrated embodiment supports batch execution. In such embodiments, multiple delta_CP values may be processed in sequence, in parallel, or in grouped execution, with each input value producing a corresponding eta_B value and a corresponding set of nucleosynthesis outputs. Batch execution may be implemented through loop-based execution, job scheduling, vectorized orchestration, distributed computation, GPU processing, or another suitable execution strategy.

In some embodiments, the BBN-integrated embodiment further includes optional metadata associated with the nucleosynthesis stage. Such metadata may include, by way of example, the identity of the selected BBN engine, engine version, compile configuration, runtime settings, output selection mode, execution timing, validation status, or cross-platform consistency indicators. Such metadata may support reproducibility, auditability, and engineering validation, but need not be required in every embodiment.

In certain preferred embodiments, the BBN-integrated workflow is used to generate abundance outputs for comparison with benchmark cosmological or observational values. For example, a worked embodiment may compute eta_B for a selected delta_CP value and then generate helium-4 and deuterium outputs for comparison against benchmark values. In such embodiments, the resulting comparison may be included in a validation mode, report, or example section of the system. However, the core identity of the BBN-integrated embodiment remains the use of the deterministically computed eta_B as the input to the nucleosynthesis computation.

In some embodiments, the BBN-integrated embodiment may share components with the eta-only mode, such that the same front-end kernel computes eta_B in both modes and a downstream branch determines whether nucleosynthesis outputs are also generated. In other embodiments, the eta-only mode and the BBN-integrated mode may be exposed as distinct user-selectable or system-selectable operational paths. In either case, the BBN-integrated embodiment remains closely tied to, and dependent upon, the same deterministic fixed-formula eta_B kernel disclosed herein.

Accordingly, the BBN-integrated embodiment provides a practical application of the deterministic eta_B computation in which a single computed baryon-to-photon ratio derived from delta_CP is used to drive a nucleosynthesis engine and generate one or more primordial abundance outputs, without requiring an internal eta_B fitting stage within the disclosed workflow.

As shown in FIG. 5, certain software and service embodiments may include a standalone library 500, a command-line or workstation embodiment 502, a REST interface 504, a batch or RPC interface 506, an eta-only mode 508, a full-BBN mode 510, an output formatter 512, and an optional logging, cache, or persistence block 514. FIG. 5 is illustrative of software packaging and access mechanisms built around the disclosed formula kernel and, in certain embodiments, the BBN-integrated workflow.

In certain embodiments, the disclosed deterministic baryogenesis and optional BBN-yield workflow is implemented as a software architecture comprising one or more functional modules. The modules described in this section are provided to illustrate concrete make-and-use implementations of the disclosed invention. The disclosed invention is not limited to any particular software partitioning, naming convention, execution environment, or module boundary unless expressly recited in a claim.

In some embodiments, the software architecture includes an input handler module configured to receive a CP-phase input value, delta_CP, from one or more sources. The input handler module may receive delta_CP from a user interface, a command-line argument, a file, a database, a network request, an experimental data feed, a software call, a batch job, or another machine-readable source. The input handler module may also associate the received input with one or more metadata items, such as source information, timestamps, uncertainty values, or execution identifiers.

In certain embodiments, the software architecture further includes a range-normalization or preprocessing module configured to perform one or more optional preprocessing operations on the received delta_CP value. Such operations may include parsing, type validation, range checking, remapping to delta_bar_CP, source-selection logic when multiple candidate values are available, provenance tagging, or preservation of both raw and processed values for audit or reporting purposes.

In preferred embodiments, the software architecture includes a prefactor module configured to provide the fixed prefactor A used in the closed-form eta_B computation. In some implementations, the prefactor module stores a predetermined value of A. In other implementations, the prefactor module computes or assembles A from constituent fixed terms, including X_opt and one or more additional disclosed factors. The prefactor module may perform this operation at runtime, initialization time, compile time, configuration time, or another suitable stage, provided that A remains fixed within the disclosed model architecture. In certain embodiments, the software architecture includes a formula engine module configured to compute eta_B from delta_CP according to the fixed closed-form relation. The formula engine module may receive the selected phase value from the input handler or preprocessing module, receive the prefactor A from the prefactor module, evaluate the sine term, perform the multiplication, and produce eta_B as a primary output. In some embodiments, the formula engine module constitutes the central computational kernel of the disclosed invention.

In some embodiments, the software architecture further includes a derivative or uncertainty module configured to compute one or more additional quantities related to the fixed eta_B relation. By way of example, this module may compute d eta_B/d delta_CP, a propagated uncertainty in eta_B, a boundedness metric, a positivity indicator, a confidence value, or another derived quantity associated with the deterministic formula kernel.

In embodiments that include primordial abundance generation, the software architecture may further include a BBN adapter module configured to interface the formula engine with a nucleosynthesis engine. The BBN adapter module may accept the computed eta_B value, place the value into a form expected by the selected BBN engine, invoke the nucleosynthesis computation, retrieve resulting outputs, and return or forward the resulting abundance values. In some embodiments, the BBN adapter module also manages engine selection, output selection, job control, version metadata, or execution-state handling.

In some embodiments, the software architecture includes an output formatter module configured to package one or more outputs of the disclosed system. The output formatter module may output eta_B alone, or may output eta_B together with abundance values, derivative values, uncertainty values, timing data, validation flags, provenance metadata, or other related data. The output formatter module may produce human-readable output, machine-readable output, structured records, serialized objects, file outputs, table rows, or network responses.

In certain embodiments, the software architecture includes a validation module configured to perform one or more quality-control, consistency, or benchmarking operations. Such operations may include checking whether eta_B lies within an expected range, whether eta_B is positive in an expected physical range, whether abundance outputs match expected benchmark values within selected tolerances, whether different execution paths agree, or whether a batch execution completed successfully. The validation module may operate continuously, selectively, on demand, or only in dedicated validation modes.

In some embodiments, the software architecture includes an optional orchestration or batch scheduler module configured to manage repeated executions of the disclosed computation over multiple input values. Such a module may queue jobs, assign execution order, coordinate parallel runs, manage retries, distribute tasks across compute resources, collect outputs, and preserve associations among inputs and outputs. In batch or large-scale embodiments, this orchestration functionality may support eta-only workflows, BBN-integrated workflows, or both.

In further embodiments, the software architecture includes one or more optional logging, caching, persistence, or storage modules. Such modules may record inputs, outputs, validation results, benchmark comparisons, runtime data, software-version information, hardware information, or other operational records. In some embodiments, cached eta_B values or cached abundance outputs may be reused when identical or equivalent inputs recur. These modules may improve efficiency, reproducibility, auditability, or user experience, but they are not required to practice the core formula kernel.

The disclosed software architecture may be implemented as a local library, an embedded component, a standalone executable, a callable API, a service backend, a batch-processing pipeline, a research tool, or another computational product. Regardless of packaging, the central software functionality remains the same: receiving delta_CP, computing eta_B from a fixed closed-form relation using a fixed prefactor, and optionally using the computed eta_B in a nucleosynthesis computation to produce one or more abundance outputs.

Accordingly, the software architecture described herein provides a concrete implementation framework for the disclosed invention while preserving the distinction between the core formula kernel, the primary BBN-integrated embodiment, and optional execution, packaging, validation, orchestration, and persistence layers.

FIG. 5 further illustrates representative deployment forms for the disclosed computation, including local, command-line, service, and batch-access embodiments.

In certain embodiments, the disclosed invention is implemented as a computation system comprising one or more processors, memory, and executable instructions configured to carry out the deterministic baryogenesis computation kernel and, in some embodiments, the BBN-integrated workflow described above. The system embodiments described in this section provide concrete implementation support for method, system, software, and apparatus claim strategies, while preserving the distinction between the inventive computation kernel and the environments in which it may be deployed.

In some embodiments, the disclosed system is implemented as a standalone local software library executing on a general-purpose computing device. In such embodiments, the library may expose one or more callable functions, routines, classes, modules, or interfaces configured to receive delta_CP, compute eta_B, and optionally generate one or more abundance outputs by invoking a nucleosynthesis engine. The local-library embodiment may be advantageous for research use, integration into existing scientific code, reproducible offline execution, or use in controlled computational environments.

In other embodiments, the disclosed system is implemented as a standalone executable, command-line tool, desktop application, or workstation-resident computation package. In such embodiments, a user may provide delta_CP through an argument, configuration file, form input, dataset, or interactive interface, and the system may return eta_B and optionally abundance outputs directly to the local environment. Such embodiments may be advantageous where direct user control, portability, or non-networked execution is desired.

In certain embodiments, the disclosed system is implemented as an embedded computational component within a larger scientific or analytical framework. For example, the deterministic eta_B kernel may be integrated into a cosmology analysis stack, a scientific workflow engine, a parameter-evaluation tool, a validation framework, or a larger data-processing pipeline. In such embodiments, the disclosed system may operate as a callable subcomponent whose primary role is to supply deterministic eta_B values and, where applicable, corresponding BBN outputs.

In some embodiments, the disclosed system is implemented as a hosted service. In such embodiments, one or more remote computing resources may receive delta_CP over a network, execute the disclosed formula kernel, optionally execute the BBN-integrated embodiment, and return one or more results to a client system. The hosted-service embodiment may support interactive requests, scheduled jobs, automated workflows, or programmatic access by downstream systems. However, the presence of a network or hosting layer does not alter the core disclosed computation.

In further embodiments, the disclosed system is implemented as a batch or remote-procedure-call service configured to process multiple inputs in grouped or scheduled execution. In such embodiments, a request may contain multiple delta_CP values, and the system may return a corresponding set of eta_B outputs and, where selected, a corresponding set of abundance outputs. Such embodiments may be advantageous for scan replacement workflows, large-scale sensitivity analyses, forecast generation, or validation studies.

In certain embodiments, the disclosed system is implemented in an edge, appliance, or embedded-device form factor. For example, the system may be configured as a dedicated scientific compute appliance, a field-deployable compute unit, an instrument-adjacent processor, or another embedded platform capable of executing the disclosed deterministic formula kernel. In some embodiments, the embedded device may further include local acceleration hardware or an integrated nucleosynthesis engine. Such embodiments may be useful where low latency, reduced bandwidth dependence, or localized execution is desirable.

In some embodiments, the disclosed system is implemented across a plurality of computing nodes or instances. For example, the system may be deployed in a clustered, horizontally scaled, distributed, containerized, or otherwise replicated environment. In such embodiments, one or more instances may execute eta-only computations, one or more instances may execute BBN-integrated computations, and an orchestration layer may distribute work among those instances. Such deployment choices may improve throughput, resilience, or operational scalability, but they do not define the inventive subject matter.

In certain implementations, the system may include one or more memories or storage devices configured to hold executable instructions, prefactor data, input records, output records, validation results, cached computations, benchmark values, metadata, or configuration information. The system may further include communication interfaces, user interfaces, display components, storage interfaces, accelerator interfaces, or external-engine interfaces. Such components may support practical operation of a particular deployment, but the disclosed invention does not require any specific interface set except as expressly recited in a claim.

In such implementations, one or more processors may execute instructions stored in memory to perform the operations described herein, including receiving delta_CP, optionally validating or remapping delta_CP, retrieving or deterministically assembling a fixed prefactor A, evaluating a sine term, computing eta_B, optionally invoking a nucleosynthesis engine using the computed eta_B, and generating one or more outputs. The system may further include one or more network interfaces for receiving inputs and transmitting outputs, and one or more storage devices for storing reference runs, validation thresholds, or execution logs.

In some embodiments, the same deployed system supports multiple operational modes. For example, the system may provide an eta-only mode, a BBN-integrated mode, a validation mode, a batch mode, a forecast mode, or another configuration-controlled execution path. Different operational modes may share the same front-end formula kernel and differ only in the presence or absence of downstream processing steps, reporting steps, or validation steps.

In certain preferred embodiments, the disclosed system comprises at least:
(a) an input-processing component configured to receive delta_CP;
(b) a formula engine configured to compute eta_B from delta_CP according to a fixed closed-form relation using a fixed prefactor; and
(c) an output component configured to output eta_B.

In some preferred embodiments, the system further comprises:
(d) a nucleosynthesis component configured to receive the computed eta_B and generate one or more primordial abundance outputs.

Accordingly, the disclosed system embodiments span local, embedded, hosted, batch, distributed, and appliance-style deployments, while preserving the same inventive center: a deterministic fixed-formula eta_B computation kernel and, in primary applied embodiments, a BBN-integrated computation architecture built around that kernel.

FIG. 5 further illustrates representative interface pathways, including eta-only and full-BBN access modes.

In certain embodiments, the disclosed deterministic baryogenesis computation kernel and the optional BBN-integrated workflow are exposed through one or more software interfaces. The interface embodiments described in this section are subordinate implementation embodiments and are provided to illustrate practical access mechanisms rather than to define the core invention.

In some embodiments, the disclosed system exposes a programmatic interface through one or more callable functions, methods, procedures, classes, modules, or library entry points. In such embodiments, a calling process may supply delta_CP as an argument or structured input, and the disclosed system may return eta_B alone or eta_B together with one or more abundance outputs and optional metadata.

In other embodiments, the disclosed system exposes a network-accessible interface. By way of example, a network request may contain a delta_CP value, an operational mode selection, an output-selection instruction, a batch payload, or one or more formatting preferences. In response, the disclosed system may return eta_B, one or more abundance outputs, and optional related information, such as derivative values, uncertainty values, validation flags, execution timing, provenance information, or engine-identification data.

In one representative interface embodiment, the disclosed system may expose an eta-only path in which a request containing delta_CP causes the system to compute eta_B and return the computed eta_B without invoking a nucleosynthesis engine. In another representative embodiment, the disclosed system may expose a BBN-integrated path in which a request containing delta_CP causes the system to compute eta_B, execute a nucleosynthesis computation using the computed eta_B, and return one or more abundance outputs together with eta_B.

In some embodiments, the disclosed interface supports batch processing. For example, a single request may include multiple delta_CP values, and the system may return a corresponding set of eta_B values or abundance-output packages. In such embodiments, the interface may preserve one-to-one association among each input value, any optional remapped value, the corresponding eta_B result, and any associated downstream outputs.

In certain embodiments, the disclosed interface provides output in a machine-readable format. By way of example, the output may be expressed as a structured object, serialized record, message payload, array, table, file, or another machine-readable format suitable for downstream computational use. In other embodiments, the disclosed interface may additionally or alternatively provide human-readable output, such as a displayed value, report line, log entry, console output, or graphical presentation.

In one non-limiting example, an interface request may specify a selected computation mode. A first mode may request eta_B only. A second mode may request eta_B together with a selected set of abundance outputs. A third mode may request sensitivity information, validation data, or uncertainty information. A fourth mode may request batch evaluation across multiple phase inputs. The manner in which such modes are selected may vary by implementation and may be controlled by configuration settings, request parameters, command-line arguments, menu selections, or other input mechanisms.

In some embodiments, the disclosed interface further supports optional output-selection logic. For example, a requester may specify whether to receive all available abundance outputs, a selected subset of abundance outputs, eta_B only, or eta_B with supplementary derivative or uncertainty information. Such output-selection logic may improve efficiency or usability in particular applications, but does not alter the underlying deterministic computation.

In certain implementations, the interface may include one or more optional validation or error-reporting mechanisms. For example, the system may return status indicators reflecting missing inputs, malformed inputs, unsupported operational requests, failed remapping, failed nucleosynthesis execution, invalid output states, or validation-check results. Such mechanisms may improve robustness and interoperability, but are not required in every embodiment. In some embodiments, the disclosed interface is implemented as a REST-style interface, a remote-procedure-call interface, a streaming interface, a file-based interface, a message-queue interface, an internal software API, or another communication mechanism. The particular interface protocol is not critical to the invention. The same underlying fixed-formula eta_B computation kernel may be exposed through multiple interface types without changing the identity of the disclosed subject matter.

Thus, the interface embodiments described herein provide practical access mechanisms for invoking the deterministic baryogenesis computation kernel and, where selected, the BBN-integrated workflow. However, the inventive subject matter remains the fixed-formula computation of eta_B from delta_CP and the closely related use of that computed eta_B in a nucleosynthesis computation, rather than the particular interface protocol through which those functions are invoked.

As shown in FIG. 6, certain accelerated embodiments may include a CPU path 600, a vectorized CPU path 602, a GPU path 604, an FPGA path 606, a fixed-point block 608, a sine-approximation block 610, a throughput or latency monitoring block 612, and a cross-platform verification block 614. FIG. 6 illustrates representative hardware and accelerated implementations of the disclosed deterministic baryogenesis computation kernel and, in certain embodiments, related validation features.

In certain embodiments, the disclosed deterministic baryogenesis computation kernel and the optional BBN-integrated workflow are implemented using hardware-accelerated or performance-optimized computation resources. The embodiments described in this section are implementation embodiments that may improve throughput, latency, power efficiency, batching capacity, or deployment flexibility, but do not alter the core inventive subject matter.

In some embodiments, the disclosed computation is executed on a general-purpose central processing unit (CPU). In such embodiments, the fixed closed-form relation for eta_B may be evaluated using scalar instructions, floating-point routines, compiler-optimized math libraries, or other standard numerical mechanisms. A CPU embodiment may be used for local execution, workstation execution, embedded execution, server execution, validation workflows, or integration into existing scientific software environments.

In certain embodiments, the disclosed computation is executed using vectorized or otherwise accelerated CPU logic. For example, one or more batches of delta_CP values may be processed using vector instructions, parallelized numerical routines, instruction-set-specific optimizations, pipelined execution, or compiler-assisted acceleration. Such embodiments may be advantageous for repeated eta_B evaluation, batch-mode operation, sensitivity studies, or multi-input workflows.

In some embodiments, the disclosed computation is executed on a graphics processing unit (GPU). In such embodiments, a plurality of delta_CP inputs may be processed in parallel, and the fixed-formula eta_B computation may be mapped to GPU-executed kernels, vectorized processing lanes, or other many-core execution resources. In embodiments that include BBN integration, the GPU may be used for the formula kernel alone, for surrounding orchestration, or for one or more portions of a broader batched computation workflow.

In certain embodiments, the disclosed computation is executed using field-programmable gate array (FPGA) logic or other configurable hardware. In such embodiments, one or more of the following may be implemented in hardware: input handling, optional remapping logic, prefactor handling, sine evaluation, multiplication by the prefactor, derivative computation, uncertainty handling, output generation, or interface-related logic. In some embodiments, the disclosed fixed-formula eta_B kernel is especially well suited to pipelined hardware implementation because of its compact deterministic structure.

In some embodiments, the disclosed computation is implemented in fixed-point arithmetic. In other embodiments, the computation is implemented in floating-point arithmetic. In still other embodiments, different portions of the workflow may use different numeric representations. For example, a formula-only eta_B kernel may use fixed-point arithmetic while surrounding control logic, metadata handling, or BBN integration uses floating-point or mixed-precision processing. The selected numeric representation may vary according to precision requirements, hardware constraints, throughput targets, or implementation policy.

In certain embodiments, the sine term of the closed-form relation is computed using an approximation mechanism suitable for accelerated execution. By way of example, such mechanisms may include lookup tables, polynomial approximations, piecewise approximations, hardware trigonometric blocks, vectorized math libraries, fixed-point approximation logic, or other computational techniques. The choice of sine-evaluation implementation may vary without changing the fixed closed-form nature of the disclosed eta_B relation.

In some embodiments, the accelerated implementation further includes one or more monitoring or validation mechanisms. For example, the system may monitor throughput, latency, energy consumption, thermal state, numeric precision, or execution success. In some embodiments, outputs generated by one accelerated path may be compared against outputs generated by another path, such as CPU versus GPU or CPU versus FPGA, to verify consistency of eta_B values and, where applicable, downstream abundance outputs.

In certain embodiments, the disclosed system includes a cross-platform verification mode in which the same delta_CP input or batch of inputs is processed through multiple hardware or software implementations and the resulting eta_B values, derivative values, uncertainty values, or abundance outputs are compared. Such comparisons may be used to validate implementation correctness, confirm numeric agreement, detect approximation drift, or establish engineering acceptance criteria.

In some embodiments, hardware acceleration is used only for the formula-only eta_B kernel. In other embodiments, hardware acceleration is used for broader portions of the workflow, including batch scheduling, interface servicing, output packaging, validation logic, or one or more portions of a BBN-integrated pipeline. Whether acceleration is applied narrowly or broadly may vary by embodiment and deployment objective.

In certain preferred embodiments, the disclosed hardware and accelerated embodiments preserve the same functional sequence as the non-accelerated embodiments: receive a selected phase value, optionally preprocess the phase value, retrieve or assemble the fixed prefactor, evaluate the sine term, compute eta_B, and optionally forward eta_B to a nucleosynthesis engine. Thus, acceleration changes the manner of execution, but not the inventive logic being executed. In some embodiments, the disclosed accelerated embodiments are particularly advantageous for high-volume eta-only evaluations, repeated sensitivity calculations, precomputed lookup-table generation, distributed-service operation, forecast generation, or real-time or near-real-time computation settings. In embodiments that include a BBN engine, acceleration may also support multi-request serving, batch abundance generation, or high-throughput comparison workflows. Accordingly, the hardware and accelerated embodiments described herein preserve support for CPU, vectorized CPU, GPU, FPGA, fixed-point, floating-point, mixed-precision, approximate-sine, and cross-platform validation implementations while maintaining the same inventive center: deterministic computation of eta_B from delta_CP by a fixed closed-form relation using a fixed prefactor, optionally coupled to a BBN computation that generates one or more abundance outputs.

As shown in FIG. 7, a validation and uncertainty-handling workflow may include an example delta_CP input 700, a computed eta_B value 702, a benchmark comparison block 704, an abundance comparison block 706, an uncertainty propagation block 708, a conventional scan-based workflow block 710, a deterministic disclosed-workflow block 712, and a validation-criteria block 714. FIG. 7 illustrates representative ways in which the disclosed formula kernel and the BBN-integrated embodiment may be checked, compared, and characterized without changing the underlying inventive computation.

In certain embodiments, the disclosed deterministic baryogenesis computation kernel and the optional BBN-integrated workflow are operated in a validation mode or are otherwise subjected to one or more internal consistency checks. The validation features described in this section may be used to characterize correctness, robustness, agreement with benchmark values, or implementation consistency, but need not be required in every embodiment.

In some embodiments, validation includes evaluating the disclosed fixed-formula relation at a selected CP-phase input and comparing the resulting eta_B value against a benchmark or reference baryon-to-photon ratio. In one representative demonstrated case, a selected delta_CP input value of approximately 1.20 radians is processed through the disclosed formula kernel to generate eta_B, and the resulting value is compared against a benchmark cosmological value inferred from Planck-era baryon-density results. In embodiments that include a nucleosynthesis engine, one or more generated abundance outputs, including helium-4 and deuterium outputs, may likewise be compared against benchmark values, expected ranges, or published constraints, while any persistent lithium-related discrepancy may be expressly reported rather than obscured. Such benchmark comparison may be used for reporting, regression testing, implementation validation, or scientific characterization of the disclosed deterministic kernel and the BBN-integrated embodiment.

In embodiments that include a nucleosynthesis engine, validation may further include comparing one or more generated abundance outputs against benchmark abundance values. By way of example, the system may compare generated helium-4 abundance, deuterium abundance, lithium-7 abundance, helium-3 abundance, or any selected subset thereof against stored benchmark values, published values, expected ranges, validation targets, or prior-run reference outputs. Such comparisons may be used to characterize performance of the BBN-integrated embodiment, confirm correct engine operation, or document correspondence between generated outputs and selected reference values.

In certain embodiments, the disclosed validation logic further includes explicit recognition of known discrepancy conditions. For example, an implementation may report that one or more generated outputs, such as a lithium-related output, remain discrepant relative to selected observational values even where other outputs, such as helium-4 or deuterium, exhibit closer agreement. Including such discrepancy reporting may improve scientific transparency and may distinguish validated agreement in certain output channels from unresolved differences in other channels.

In some embodiments, the disclosed system performs one or more internal mathematical or computational checks on the eta_B output itself. Such checks may include determining whether eta_B is positive over an expected evaluation range, whether the absolute value of eta_B is bounded by the prefactor A, whether eta_B falls within an expected order of magnitude, whether the output is finite and numerically well-formed, or whether repeated evaluation of the same input produces identical or sufficiently similar output values. These checks may be applied continuously, selectively, on demand, or only in validation mode.

In certain embodiments, the disclosed system further includes derivative-based or uncertainty-based validation. For example, the system may compute d eta_B/d delta_CP and may use that quantity to estimate or monitor sensitivity of eta_B to variation in delta_CP. In some embodiments, the system may propagate an uncertainty associated with delta_CP into a corresponding eta_B uncertainty estimate and may report or compare that uncertainty against expected thresholds, reporting targets, or forecast ranges.

In some embodiments, validation includes cross-platform consistency checking. For example, the same delta_CP value or batch of values may be processed through scalar CPU logic, vectorized CPU logic, GPU logic, FPGA logic, or any selected combination thereof, and the resulting eta_B values and, where applicable, abundance outputs may be compared. Such comparison may be used to identify numerical drift, approximation error, hardware-specific deviations, implementation bugs, or unacceptable differences between execution paths. In certain embodiments, the system applies one or more acceptance criteria to determine whether a validation run is satisfactory. Such acceptance criteria may include, by way of example: (a) a selected maximum deviation between a generated abundance output and a benchmark value; (b) a selected maximum difference between two independently implemented eta_B computations; (c) satisfaction of positivity or boundedness conditions; (d) a selected tolerance on uncertainty propagation outputs; (e) successful completion of a batch run without execution errors; or (f) successful generation of required outputs within a selected timing, throughput, or reliability target. The particular acceptance criteria used may vary by embodiment, deployment environment, or validation objective. In non-limiting examples, a cross-platform eta_B check may be declared PASS when independently computed eta_B values differ by no more than a predetermined tolerance for the selected numeric representation (for example, a fixed absolute tolerance, a fixed relative tolerance, or bit-identical agreement for a specified fixed-point width), and a nucleosynthesis-output regression test may be declared PASS when one or more selected abundance outputs remain within a predetermined tolerance band relative to a stored reference run produced using a specified engine version and configuration.

The particular acceptance criteria used may vary by embodiment, deployment environment, or validation objective.

In some embodiments, the disclosed validation process is performed during development, regression testing, certification, release qualification, benchmark publication, or system commissioning. In other embodiments, validation is performed dynamically during production use, periodically during operation, upon user request, or automatically in response to a detected software, hardware, or data-source change.

In embodiments that include networked or service-based operation, validation may further include service-level checks, such as whether a selected request class completes successfully, whether batch responses preserve input-output association, whether required metadata fields are present, whether output formatting is correct, or whether target response times or throughput levels are maintained. Such service-level checks may be useful for engineering assurance, but are distinct from the scientific validity of the underlying fixed-formula eta_B computation.

In certain embodiments, validation results are recorded in a report, log, data record, benchmark file, dashboard, comparison table, machine-readable output package, or another persistent or transient output structure. Such recorded validation information may be used to support reproducibility, auditability, engineering verification, scientific communication, or claim-support documentation.

Accordingly, the validation and internal consistency features described herein provide optional but useful mechanisms for confirming the operation of the disclosed formula kernel and the BBN-integrated embodiment, while preserving the distinction between the core inventive computation and the engineering, benchmarking, and scientific-comparison procedures used to characterize that computation.

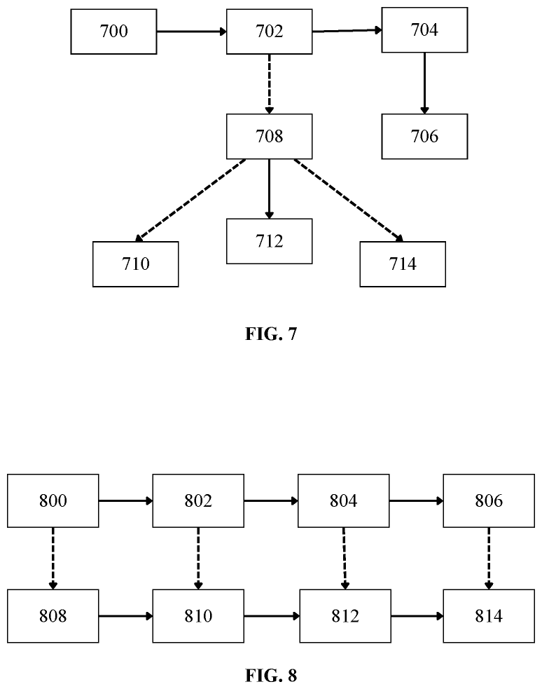

FIG. 3 supports the fixed-prefactor discussion described in this section, and FIG. 8 illustrates the broader disclosure taxonomy within which the formally supported material is positioned.

In certain embodiments, one or more mathematical properties associated with the disclosed deterministic baryogenesis computation kernel are supported by formal verification or machine-checked mathematical formalization. Such formal support may reinforce the disclosed fixed-formula architecture and fixed-prefactor framing, while remaining distinct from the operational disclosure set forth elsewhere herein.

In preferred embodiments, the disclosed formal support includes one or more machine-checked results associated with the eta_B relation and its prefactor structure. Representative formally supported properties may include, by way of example:
(a) positivity of the prefactor A; (b) derivation of the prefactor from X_opt; (c) positivity of eta_B over a selected physical phase range; (d) boundedness of eta_B relative to the prefactor; (e) the single-input character of the core formula kernel; (f) order-of-magnitude characterization of the prefactor or eta_B output; and(g) non-fitted treatment of the prefactor within the disclosed model architecture.

In certain embodiments, the formal support may be identified using names or labels associated with machine-checked proof artifacts, including, by way of example: prefactor_positive, prefactor_from_phi, eta_positive, eta_bounded, single_input, order_of_magnitude, parameter_free.

Such labels are examples of formally supported properties and may be referenced in the specification, appendices, internal development records, or supporting materials to identify the nature of the formal mathematical support associated with the disclosed kernel.

In some embodiments, the disclosed formal support is relevant to the characterization of the invention. For example, formal support for prefactor_from_phi is consistent with the disclosed framing that the prefactor A is fixed within the model architecture rather than selected or fit during operation. Formal support for single_input is consistent with the disclosed framing that the core eta_B computation requires only delta_CP as an external scientific input. Formal support for eta_positive and eta_bounded is consistent with the mathematical regularity of the disclosed fixed-formula relation across selected ranges or under selected conditions.

In certain embodiments, the specification distinguishes between mathematically formalized properties and empirically validated engineering or scientific results. Thus, machine-checked support for mathematical properties of the formula kernel is different in kind from benchmark comparisons, runtime measurements, throughput measurements, cross-platform engineering tests, or agreement comparisons against observational or cosmological reference values.

In some embodiments, the identified formal mathematical results may also support claim formulations directed to a fixed prefactor, derivation of the prefactor from X_opt, the single-input structure of the core kernel, positivity or boundedness of the relation, or avoidance of internal cosmological fitting. However, the disclosed invention is not limited to embodiments in which proof artifacts are separately distributed, executed, or exposed to end users.

In certain embodiments, the disclosed formal support may additionally be used to inform internal validation, engineering confidence, or scientific communication. For example, the mathematical properties identified above may be referenced when evaluating whether a particular implementation conforms to the intended fixed-formula architecture. Implementation correctness in software or hardware may nevertheless remain subject to numerical validation, integration testing, and engineering verification, as described elsewhere herein.

Accordingly, the formal verification and credibility anchors described in this section reinforce the fixed-prefactor, fixed-formula, single-input, and non-fitted character of the deterministic baryogenesis kernel, while remaining distinct from the empirical and engineering evidence used to validate particular implementations or examples.

FIG. 7 provides a representative framework for organizing example inputs, computed outputs, benchmark comparisons, uncertainty handling, and validation criteria associated with the disclosed computation.

The following examples illustrate selected embodiments of the disclosed deterministic baryogenesis computation kernel and the related BBN-integrated workflow. These examples distinguish demonstrated embodiments from prophetic, downstream, or continuation-oriented material. Unless expressly stated otherwise, the examples are non-limiting.

In one demonstrated example, a selected CP-phase input value delta_CP is provided to the disclosed computation kernel. In a representative case, delta_CP is approximately 1.20 radians. The system computes eta_B according to the fixed closed-form relation eta_B=A sin(delta_CP), using a preferred prefactor value corresponding to the disclosed fixed architecture. The computed eta_B is then supplied to a BBN engine, such as an AlterBBN-based computation path, to generate one or more abundance outputs, including helium-4 abundance, deuterium abundance, lithium-7 abundance, and helium-3 abundance. In representative implementations of this example, helium-4 and deuterium outputs may be compared against benchmark values, while any persistent lithium-related discrepancy may be expressly reported. This demonstrated example shows that the disclosed deterministic eta_B kernel is not merely an abstract mathematical statement, but a make-and-use computation architecture capable of producing concrete abundance outputs from a measured delta_CP input.

In another demonstrated example, the disclosed system receives a sequence of delta_CP values spanning a selected phase interval, such as a range from 0 to pi or a selected subrange thereof. For each input value, the system computes eta_B according to the fixed closed-form relation. In embodiments that include a nucleosynthesis engine, the system also computes one or more abundance outputs for each corresponding eta_B value.

This example may generate a table, plot, batch output file, or structured data package showing how eta_B and, where applicable, one or more abundance outputs vary with delta_CP. In some embodiments, derivative values or uncertainty estimates are also generated for one or more points in the scan.

In another demonstrated example, the disclosed system is operated in eta-only mode. A selected delta_CP value is received, the fixed-formula relation is evaluated, and eta_B is output without invoking a nucleosynthesis engine.

In some embodiments, the eta-only output is provided as a scalar. In other embodiments, the eta-only output is provided together with one or more related data fields, such as derivative information, uncertainty information, timing information, provenance information, or a validation flag. This example illustrates that the formula-only embodiment is itself a complete implementation of the disclosed invention.

In another demonstrated example, one or more selected delta_CP values are processed through multiple implementations of the disclosed computation, such as a scalar CPU implementation, a vectorized CPU implementation, a GPU implementation, an FPGA implementation, or another pair or set of independent execution paths. The resulting eta_B outputs are compared for consistency. In embodiments that include BBN integration, one or more abundance outputs may also be compared.

This example illustrates cross-platform validation, numeric agreement checking, and portability of the fixed-formula kernel across software and hardware embodiments.

In one prophetic example, the disclosed system receives a future or forecasted delta_CP input range associated with an anticipated experimental precision regime. The system computes corresponding eta_B values and optionally associated abundance outputs and uncertainty bands, thereby generating a forecast package for later comparison against future experimental or cosmological data.

This example illustrates how improved delta_CP measurement precision could sharpen deterministic eta_B prediction and downstream abundance estimates.

In one downstream example, a computational workflow that would otherwise evaluate multiple candidate eta_B values is modified to receive a single eta_B value computed from delta_CP by the disclosed fixed-formula kernel. The downstream workflow then proceeds using that single computed eta_B value.

This example illustrates use of the disclosed computation in a larger scientific or cosmological workflow.

In one prophetic or downstream example, the disclosed fixed-formula kernel is deployed in an embedded or real-time environment. A selected delta_CP input is received from an external system, eta_B is computed by the fixed closed-form relation, and the resulting eta_B value is either reported directly or supplied to a downstream component for further analysis or monitoring.

Depending on the embodiment, the downstream component may include a local abundance-generation engine, a validation module, a monitoring system, or a scientific planning system.

In one optional example, the disclosed formula-only kernel or BBN-integrated workflow is exposed through an educational, exploratory, or visualization-oriented interface. A user supplies delta_CP, the system computes eta_B, and the system optionally displays one or more abundance outputs, sensitivity results, or comparison values.

This example illustrates user-facing or visualization-oriented embodiments while remaining subordinate to the core scientific computation kernel and the BBN-integrated embodiment.

As shown in FIG. 8, the specification taxonomy may distinguish core subject matter 800 from preferred embodiments 802, optional embodiments 804, alternative embodiments 806, prophetic material 808, demonstrated material 810, downstream embodiments 812, and continuation-target material 814. FIG. 8 is useful for understanding that the embodiments described in this section are preserved as alternatives and not as the definitional core of the invention.

In addition to the core formula-only kernel and the primary BBN-integrated embodiment described above, the present disclosure preserves certain alternative embodiments that remain related to the disclosed deterministic baryogenesis architecture but are not required to define the core invention.

In some alternative embodiments, the disclosed eta_B computation may be extended beyond a single CP-phase input to include one or more additional phase terms or additional inputs associated with broader baryogenesis modeling. By way of example, an alternative embodiment may employ a function of multiple phase inputs, such as delta_CP together with one or more additional CP-related quantities. Such embodiments are preserved as alternatives and possible future-expansion embodiments, but the present core invention remains centered on the single-input deterministic kernel described above.

In certain alternative embodiments, the disclosed system may be configured to investigate one or more abundance-related discrepancy conditions using the deterministically computed eta_B as a starting input and then modifying one or more downstream assumptions, cross-sections, reaction-network settings, or comparison modes. For example, a lithium-focused investigative embodiment may use the disclosed fixed-formula eta_B kernel while varying one or more downstream nucleosynthesis assumptions for comparative study. Such embodiments may be useful for scientific exploration, but they do not alter the identity of the disclosed fixed-formula eta_B computation kernel.

In some alternative embodiments, the deterministically computed eta_B value may be used as an input to one or more additional scientific calculations beyond the core BBN abundance workflow. By way of example, an alternative embodiment may generate one or more derived cosmological, astrophysical, or model-selection outputs using eta_B as an input quantity. Such embodiments may preserve flexibility for later claim development or continuation practice, but should remain clearly secondary to the disclosed core kernel and the primary BBN-integrated embodiment.

In certain embodiments, the disclosed system may be configured with alternative downstream packaging or execution structures. For example, a system may expose the fixed-formula eta_B kernel through a distinct appliance, a specialized embedded device, a scientific-instrument interface, a forecasting tool, a validation framework, or another deployment architecture. These embodiments may be useful in practice, but they remain alternative implementation contexts for the same disclosed deterministic formula kernel.

In some alternative embodiments, the disclosed nucleosynthesis stage may use a different nucleosynthesis solver, a modified interface layer, a different output-selection policy, or a different reporting structure while preserving the same front-end eta_B determination from delta_CP. Accordingly, the use of a particular BBN code, adapter structure, or reporting format should not be understood as limiting the broader BBN-integrated concept unless expressly recited in a claim.

In certain embodiments, one or more alternative modes may combine the fixed-formula eta_B kernel with selected analysis, forecasting, or comparative tools. For example, a system may compute eta_B from delta_CP and then generate a report, a comparison table, a sensitivity chart, or a scenario package. Such embodiments may be useful for preserving support for broader software products and output formats, but should remain subordinate to the core computational mechanism.

The alternative embodiments described in this section are intentionally separated from the core invention so that optional expansions, investigative branches, solver substitutions, and future-facing variants do not obscure the identity of the disclosed deterministic baryogenesis kernel. Accordingly, these alternative embodiments should be understood as preserving flexibility and continuation support while leaving the core invention centered on the fixed closed-form eta_B computation from delta_CP and the closely related BBN-integrated embodiment built around that computation.

As shown in FIG. 8, downstream embodiments are separated from the core region so that downstream workflows remain subordinate to the disclosed deterministic eta_B computation kernel and the closely related BBN-integrated embodiment.

In certain embodiments, the disclosed deterministic eta_B computation kernel and the related BBN-integrated embodiment may be used within one or more downstream workflows, applications, or products. These downstream embodiments are preserved in the specification to support broader commercial and scientific use cases, but they remain subordinate to the core invention and do not redefine the inventive mechanism.

In some downstream embodiments, the deterministically computed eta_B value is used within a larger cosmological analysis workflow. For example, a workflow that would otherwise vary or fit eta_B internally may instead receive a single eta_B value computed from delta_CP by the disclosed fixed closed-form relation. The downstream workflow may then proceed using that computed eta_B value as an input to one or more subsequent calculations, simulations, comparisons, or reporting steps. Such embodiments may be advantageous in analysis environments where reduction of eta_B scan dependence is desirable.

In certain downstream embodiments, the disclosed computation is used in baryogenesis-model testing or comparison workflows. For example, a system may compute eta_B from a selected delta_CP value and compare the resulting eta_B, or one or more abundance outputs derived therefrom, against one or more reference values, benchmark datasets, observational constraints, or outputs generated by another model. Such workflows may be useful for model evaluation, benchmarking, validation studies, or comparative scientific analysis.

In some downstream embodiments, the disclosed computation is used to generate forecast or scenario packages across one or more selected delta_CP values. For example, a downstream forecasting workflow may compute eta_B values across a selected phase range and may optionally compute one or more corresponding abundance outputs. The resulting forecast package may include tables, plots, confidence intervals, scenario groupings, or other reporting structures. Such embodiments may be useful for scientific planning, analysis preparation, or downstream report generation.

In certain downstream embodiments, the disclosed eta_B computation is used as an input to a structure-formation, baryon-fraction, initial-condition, or related simulation workflow. In such embodiments, the deterministically computed eta_B value may be transformed, combined with one or more additional quantities, or incorporated into a downstream model or simulation. These uses may preserve broader application support, but they remain downstream from the disclosed eta_B kernel and the primary BBN-integrated embodiment.

In some downstream embodiments, the disclosed computation is used in an abundance-discrepancy analysis workflow. For example, one or more abundance outputs generated from the computed eta_B value may be compared with external values, observational datasets, or modified downstream assumptions in order to characterize the extent of agreement or discrepancy in a selected output channel. Such embodiments may be useful for scientific study or comparative investigation, but they should not be understood as changing the core deterministic eta_B computation itself.

In certain downstream embodiments, the disclosed computation may be packaged in educational, exploratory, visualization, or reporting tools. For example, a user-facing application may receive delta_CP, compute eta_B, optionally compute one or more abundance outputs, and present one or more results to a student, researcher, analyst, or other user. Such embodiments may improve accessibility or communication of the disclosed computation, but they remain downstream or optional packaging embodiments rather than the core invention.

In some embodiments, downstream workflows may be implemented using the eta-only mode, the BBN-integrated mode, or both. For example, a downstream application may consume eta_B directly without invoking a nucleosynthesis engine, while another downstream application may consume both eta_B and one or more abundance outputs. The fact that a downstream workflow branches from the formula-only kernel or from the BBN-integrated embodiment does not alter the inventive center of the disclosure.

The downstream embodiments described in this section are intentionally segregated from the core invention so that large-scale workflows, scientific applications, commercial packaging, or reporting tools do not overshadow the deterministic fixed-formula computation that gives rise to them. Accordingly, downstream embodiments should be understood as subordinate uses or applications of the disclosed core kernel and its closely related BBN-integrated embodiment.

As shown in FIG. 8, continuation-target material is separated from core, preferred, optional, alternative, prophetic, demonstrated, and downstream material in order to preserve future claim flexibility without redefining the present invention.

The present disclosure includes, in addition to the presently described core invention and preferred embodiments, certain alternative and future-facing subject matter that may provide context for related claim strategies in later filings. Such material is included to preserve drafting flexibility and to distinguish the presently emphasized invention from broader or differently emphasized embodiments, but should not be understood as enlarging the present priority claim beyond subject matter adequately supported by the provisional disclosure.

By way of example, such future-facing subject matter may include alternative formula embodiments, expanded accelerator implementations, broader integration with scientific workflows, expanded output products, and additional downstream applications, to the extent such subject matter is otherwise supported by the present disclosure and any applicable priority disclosure. These possibilities are preserved as drafting context only and should not be read as redefining the presently emphasized invention, which remains centered on deterministic computation of eta_B from delta_CP by a fixed closed-form relation using a fixed prefactor, together with the closely related BBN-integrated embodiment.

In some embodiments, later-developed validation results, implementation refinements, accelerator designs, integration architectures, or scientific use cases may be addressed in one or more later filings to the extent independently supported and appropriate.

What is claimed is:

1. A computer-implemented method for determining a baryon-to-photon ratio, comprising:
receiving a CP-violating phase input, delta_CP;
computing a baryon-to-photon ratio, eta_B, according to a fixed closed-form relation eta_B=A sin(delta_CP), where A is a fixed prefactor derived from stated Recognition-Physics conditions; and
outputting eta_B,
wherein delta_CP is treated as a measured input rather than a fitted cosmological parameter within the method, and
wherein A is treated as a predetermined value or a deterministically computed value based on stated fixed terms and is not iteratively fitted, optimized, scanned, or sampled as a cosmological parameter within the method.

2. The method of claim 1, wherein the fixed prefactor A is derived from a quantity X_opt, and wherein X_opt equals phi divided by pi.

3. The method of claim 1, wherein the fixed prefactor A is expressed as:
A=X_opt\hat{ }(21/2)×(m_p/T_EW)/(8 pi\hat{ }2 g_star),
wherein X_opt is a quantity equal to phi divided by pi,
wherein m_p/T_EW is an electroweak normalization term, and
wherein g_star is a statistical dilution term.

4. The method of claim 1, further comprising remapping a reported value of delta_CP into a selected physical or computational range before computing eta_B.

5. The method of claim 4, wherein the remapping comprises:
when delta_CP is less than zero, setting a remapped phase value, delta_bar_CP, equal to delta_CP+pi; and
otherwise using delta_CP without remapping.

6. The method of claim 1, further comprising computing a derivative of eta_B with respect to delta_CP.

7. The method of claim 1, further comprising performing a validation operation in which eta_B values computed using at least two different execution paths are compared to confirm consistency of the computation.

8. A computer-implemented method for determining a baryon-to-photon ratio and one or more primordial abundance outputs, comprising:
receiving a CP-violating phase input, delta_CP;
computing a baryon-to-photon ratio, eta_B, according to a fixed closed-form relation eta_B=A sin(delta_CP), where A is a fixed prefactor derived from stated Recognition-Physics conditions;
supplying the computed eta_B to a nucleosynthesis engine;
generating one or more primordial abundance outputs using the nucleosynthesis engine; and
outputting at least eta_B and the one or more primordial abundance outputs as an output package,
wherein eta_B is not fitted as a cosmological parameter within the method.

9. The method of claim 8, wherein the nucleosynthesis engine comprises a Big-Bang Nucleosynthesis engine.

10. The method of claim 8, wherein the nucleosynthesis engine comprises AlterBBN.

11. The method of claim 8, wherein the one or more primordial abundance outputs comprise one or more of helium-4 abundance, deuterium abundance, lithium-7 abundance, and helium-3 abundance.

12. The method of claim 8, further comprising comparing at least one selected primordial abundance output with a reference output to evaluate consistency of the nucleosynthesis computation.

13. A computation system comprising:
an input-processing component configured to receive a CP-violating phase input, delta_CP;
a formula engine configured to compute a baryon-to-photon ratio, eta_B, according to a fixed closed-form relation eta_B=A sin(delta_CP), where A is a fixed prefactor derived from stated Recognition-Physics conditions; and
an output component configured to output eta_B.

14. The system of claim 13, further comprising a nucleosynthesis component configured to receive the computed eta_B and generate one or more primordial abundance outputs.

15. The system of claim 14, wherein the system is configured to operate in:
an eta-only mode that outputs eta_B without executing the nucleosynthesis component; and
a BBN-integrated mode that supplies the computed eta_B to the nucleosynthesis component to generate the one or more primordial abundance outputs.

16. A non-transitory computer-readable medium storing instructions that, when executed by one or more processors, cause the one or more processors to:
receive a CP-violating phase input, delta_CP;
compute a baryon-to-photon ratio, eta_B, according to a fixed closed-form relation eta_B=A sin(delta_CP), where A is a fixed prefactor derived from stated Recognition-Physics conditions; and
output eta_B,
wherein delta_CP is treated as a measured input rather than a fitted cosmological parameter, and
wherein A is not iteratively fitted, optimized, scanned, or sampled as a cosmological parameter within the instructions.

17. The non-transitory computer-readable medium of claim 16, wherein the instructions further cause the one or more processors to supply the computed eta_B to a nucleosynthesis engine and output one or more primordial abundance outputs.

18. A hardware accelerator configured to compute a baryon-to-photon ratio, eta_B, from a CP-violating phase input, delta_CP, according to a fixed closed-form relation eta_B=A sin(delta_CP), where A is a fixed prefactor derived from stated Recognition-Physics conditions, wherein the hardware accelerator comprises fixed-point logic, floating-point logic, or mixed-precision logic configured to evaluate the fixed closed-form relation and output eta_B.

19. The hardware accelerator of claim 18, wherein the hardware accelerator comprises FPGA logic.

20. The hardware accelerator of claim 18, wherein the hardware accelerator comprises logic configured to compute a sine term using a lookup table, a polynomial approximation, or a hardware trigonometric block.
